(19) United States
(12) Patent Application Publication
(10) Pub. No.: US 2014/0346704 A1
(43) Pub. Date: Nov. 27, 2014

(54) METHOD FOR PRODUCING AN ABSORBENT PAPER PRODUCT HAVING VISUAL ELEMENTS

(71) Applicant: The Procter & Gamble Company, Cincinnati, OH (US)

(72) Inventors: Emma Lynn SARTINI, Cincinnati, OH (US); Kathryn Christian KIEN, Cincinnati, OH (US); Marian Frances SMITH, Springdale, OH (US); Lee Ann LUIPOLD, Cincinnati, OH (US)

(73) Assignee: The Procter & Gamble Company, Cincinnati, OH (US)

(21) Appl. No.: 13/899,897

(22) Filed: May 22, 2013

(51) Int. Cl. B29C 59/00

(52) U.S. Cl. CPC B29C 59/007; B29C 59/00
USPC 264/153; 264/293

(57) ABSTRACT

A method of manufacturing a strip of absorbent paper product. The method includes: providing a strip that has a strip width, which has a first dimension, disposed between a first edge and a second edge and a centerline extending in a longitudinal direction equidistant between the first edge and the second edge; imparting a pattern of first design elements in a central region wherein each first design element comprises a visual center point and the pattern has a pattern centerline in the longitudinal direction, the pattern of first design elements being disposed within a central width having a second dimension, the second dimension being less than the first dimension, and the central region extending laterally outwardly on each side of the centerline; and, imparting a plurality of second design elements on the strip, wherein at least one of second design elements is disposed in the central region.

### FIELD OF THE INVENTION

The disclosure relates to embossed and/or printed absorbent paper products, such as bath tissue, facial tissue, and paper towels and to methods of making such paper products.

### BACKGROUND OF THE INVENTION

Absorbent paper products, such as bath tissue, facial tissue, and paper towels are well known. Such products are commonly used in households, businesses, restaurants, shops, and the like. Often absorbent paper products are embossed or printed to provide an aesthetically pleasing look to an exposed surface of the absorbent paper product. Embossing is also known to be useful for aiding in bonding multiple plies of absorbent paper together to form a multi-ply absorbent paper product.

Methods for making absorbent paper products are also well known. Absorbent paper products can be made by wet or dry processes. Typically absorbent paper products are made by wet laying processes in which a fibrous slurry of cellulosic fibers is deposited on a forming wire and thereafter dried by known processes such as through-air-drying, press felts, and Yankee drum drying. Absorbent paper products can be creped or non-creped, and can be converted after drying into multi-ply, embossed, printed, and/or rolled absorbent paper products.

Manufacturers of absorbent paper products desire that consumers of such products be able to distinguish between the varieties of absorbent paper products on the market. One way a manufacturer can distinguish its product from the products of other manufacturers is by emboss and/or print designs visible to the consumer. For example, in a rolled format, such as is common for bath tissue and paper towels, the last wrap of absorbent paper product can be exposed and visible to a consumer. If the rolled absorbent paper product is wrapped in a package that is at least partially transparent, an emboss and/or print design pattern can be seen through the packaging. Similarly, an emboss and/or print design pattern can be seen when the absorbent paper product is being used, such as to wipe up a spill. A consumer can make a buying decision based on a preferred emboss and/or print design pattern.

Further to the above, manufacturers have come to realize that consumers prefer an emboss and/or print pattern that comprises large, discrete elements that do not get cut off at the edge of the rolled absorbent paper product. However, due to the restrictions of the manufacturing process, manufacturers have found it difficult to produce absorbent products that comprise a large, discrete element that does not get cut off at the edge. More specifically, manufacturers are unable to ensure that an absorbent product comprising an emboss and/or print pattern that is intended to be substantially centered actually is centered, also referred to as being registered. Accordingly, there is a continuing unmet need for an absorbent paper product that appears to comprise a substantially centered pattern.

Still further, manufacturers of absorbent paper products often manufacture products having one or more plies of absorbent tissue. Having more than one ply requires manufacturers to sufficiently bond the plies such that they remain substantially connected during use. Manufacturers have commonly used embossed areas to bind the plies at the edges of the sheet and over the surface of the sheet. Thus, there is an unmet need for an absorbent paper product comprising design elements that are aesthetically pleasing and yet facilitate binding edges of multi-ply absorbent paper products.

### SUMMARY OF THE INVENTION

A method of manufacturing a strip of absorbent paper product is disclosed. The method includes the steps of:

providing a strip, the strip having a strip width comprising a first dimension disposed between a first edge and a second edge opposite the first edge and a centerline extending in a longitudinal direction equidistant between the first edge and the second edge;

imparting a pattern of first design elements in a central region wherein each first design element comprises a visual center point and the pattern has a pattern centerline in the longitudinal direction, the pattern of first design elements being disposed within a central width having a second dimension, the second dimension being less than the first dimension, and the central region extending laterally outwardly on each side of the centerline; and

imparting a plurality of second design elements on the strip, wherein at least one of second design elements is disposed in the central region, and wherein at least one of the second design elements is disposed in at least one of a first edge region and the second edge region, the first edge region and a second edge region each extending outward from the central region toward at least one of the first edge and the second edge.

### BRIEF DESCRIPTION OF THE DRAWINGS

FIG. 1 is a plan view of an absorbent paper product in accordance with one non-limiting embodiment of the present invention;

FIG. 2 is a plan view of an absorbent paper product in accordance with one non-limiting embodiment of the present invention;

FIGS. 3A-3D are a schematic representation of a design element in accordance with one non-limiting embodiment of the present invention;

FIGS. 4A-4C are a schematic representation of a design element in accordance with one non-limiting embodiment of the present invention;

FIG. 5 is an example of unconnected design elements being perceived as a unitary design element;

FIGS. 6A-6B are a schematic representation of a design element in accordance with one non-limiting embodiment of the present invention;

FIG. 7 is a plan view of an absorbent paper product in accordance with one non-limiting embodiment of the present invention;

FIG. 8 is a plan view of an absorbent paper product in accordance with one non-limiting embodiment of the present invention;

FIG. 9 is a plan view of an absorbent paper product in accordance with one non-limiting embodiment of the present invention;

FIG. 10 is a plan view of an absorbent paper product in accordance with one non-limiting embodiment of the present invention;

FIG. 11 is a plan view of an absorbent paper product in accordance with one non-limiting embodiment of the present invention;

FIG. 12 is a plan view of an absorbent paper product in accordance with one non-limiting embodiment of the present invention;

FIG. 13 is a plan view of a rolled web in accordance with one non-limiting embodiment of the present invention; and

FIG. 14 is a plan view of a rolled web in accordance with one non-limiting embodiment of the present invention.

### DETAILED DESCRIPTION OF THE INVENTION

“Fibrous structure” as used herein means a structure that comprises one or more fibrous elements. In one example, a fibrous structure according to the present invention means an association of fibrous elements that together form a structure capable of performing a function. Another nonlimiting example of a fibrous structure of the present invention is an absorbent paper product.

Non-limiting examples of processes for making fibrous structures include known wet-laid papermaking processes, air-laid papermaking processes, and wet, solution, and dry filament spinning processes, for example meltblowing and spunbonding spinning processes, that are typically referred to as nonwoven processes. Further processing of the formed fibrous structure may be carried out such that a finished fibrous structure is formed. For example, in typical papermaking processes, the finished fibrous structure is the fibrous structure that is wound on the reel at the end of papermaking. The finished fibrous structure may subsequently be converted into a finished product, e.g. a sanitary tissue product.

“Fibrous element” as used herein means an elongate particulate having a length greatly exceeding its average diameter, i.e. a length to average diameter ratio of at least about 10. A fibrous element may be a filament or a fiber. In one example, the fibrous element is a single fibrous element rather than a yarn comprising a plurality of fibrous elements.

The fibrous elements of the present invention may be spun from polymer melt compositions via suitable spinning operations, such as meltblowing and/or spunbonding and/or they may be obtained from natural sources such as vegetative sources, for example trees.

The fibrous elements of the present invention may be monocomponent and/or multicomponent. For example, the fibrous elements may comprise bicomponent fibers and/or filaments. The bicomponent fibers and/or filaments may be in any form, such as side-by-side, core and sheath, islands-in-the-sea and the like.

“Filament” as used herein means an elongate particulate as described above that exhibits a length of greater than or equal to 5.08 cm (2 in.) and/or greater than or equal to 7.62 cm (3 in.) and/or greater than or equal to 10.16 cm (4 in.) and/or greater than or equal to 15.24 cm (6 in.).

Filaments are typically considered continuous or substantially continuous in nature. Filaments are relatively longer than fibers. Non-limiting examples of filaments include meltblown and/or spunbond filaments. Non-limiting examples of polymers that can be spun into filaments include natural polymers, such as starch, starch derivatives, cellulose, such as rayon and/or lyocell, and cellulose derivatives, hemicellulose, hemicellulose derivatives, and synthetic polymers including, but not limited to polyvinyl alcohol, thermoplastic polymer, such as polyesters, nylons, polyolefins such as polypropylene filaments, polyethylene filaments, and biodegradable thermoplastic fibers such as polylactic acid filaments, polyhydroxyalkanoate filaments, polyesteramide filaments and polycaprolactone filaments.

“Fiber” as used herein means an elongate particulate as described above that exhibits a length of less than 5.08 cm (2 in.) and/or less than 3.81 cm (1.5 in.) and/or less than 2.54 cm (1 in.).

Fibers are typically considered discontinuous in nature. Non-limiting examples of fibers include pulp fibers, such as wood pulp fibers, and synthetic staple fibers such as polypropylene, polyethylene, polyester, copolymers thereof, rayon, glass fibers and polyvinyl alcohol fibers.

Staple fibers may be produced by spinning a filament tow and then cutting the tow into segments of less than 5.08 cm (2 in.) thus producing fibers.

In one example of the present invention, a fiber may be a naturally occurring fiber, which means it is obtained from a naturally occurring source, such as a vegetative source, for example a tree and/or plant. Such fibers are typically used in papermaking and are oftentimes referred to as papermaking fibers. Papermaking fibers useful in the present invention include cellulosic fibers commonly known as wood pulp fibers. Applicable wood pulps include chemical pulps, such as Kraft, sulfite, and sulfate pulps, as well as mechanical pulps including, for example, groundwood, thermomechanical pulp and chemically modified thermomechanical pulp. Chemical pulps, however, may be preferred since they impart a superior tactile sense of softness to fibrous structures made therefrom. Pulps derived from both deciduous trees (hereinafter, also referred to as “hardwood”) and coniferous trees (hereinafter, also referred to as “softwood”) may be utilized. The hardwood and softwood fibers can be blended, or alternatively, can be deposited in layers to provide a stratified web. Also applicable to the present invention are fibers derived from recycled paper, which may contain any or all of the above categories of fibers as well as other non-fibrous polymers such as fillers, softening agents, wet and dry strength agents, and adhesives used to facilitate the original papermaking

In addition to the various wood pulp fibers, other cellulosic fibers such as cotton linters, rayon, lyocell, and bagasse fibers can be used in the fibrous structures of the present invention.

“Absorbent paper product” as used herein means a soft, relatively low density fibrous structure useful as a wiping implement for post-urinary and post-bowel movement cleaning (toilet tissue), for otorhinolaryngological discharges (facial tissue), multi-functional absorbent and cleaning uses (absorbent towels) and wipes, such as wet and dry wipes. The absorbent paper product may be convolutedly wound upon itself about a core or without a core to form a sanitary tissue product roll or the sanitary tissue product may be in the form of discrete sheets.

The absorbent paper products and/or fibrous structures of the present invention may exhibit a basis weight between about 10 g/m² to about 120 g/m² and/or from about 15 g/m² to about 110 g/m² and/or from about 20 g/m² to about 100 g/m² and/or from about 30 to 90 g/m². In addition, the absorbent paper product of the present invention may exhibit a basis weight between about 40 g/m² to about 120 g/m² and/or from about 50 g/m² to about 110 g/m² and/or from about 55 g/m² to about 105 g/m² and/or from about 60 g/m² to 100 g/m².

The absorbent paper products of the present invention may exhibit a density of less than 0.60 g/cm³ and/or less than 0.30 g/cm³ and/or less than 0.20 g/cm³ and/or less than 0.15 g/cm³ and/or less than 0.10 g/cm³ and/or less than 0.07 g/cm³ and/or less than 0.05 g/cm³ and/or from about 0.01 g/cm³ to about 0.20 g/cm³ and/or from about 0.02 g/cm³ to about 0.15 g/cm³ and/or from about 0.02 g/cm³ to about 0.10 g/cm³.

The absorbent paper products of the present invention may be in the form of absorbent paper product rolls. Such absorbent paper product rolls may comprise a plurality of connected, but perforated sheets of fibrous structure, that are separably dispensable from adjacent sheets.

The absorbent paper products of the present invention may comprise additives such as softening agents, temporary wet strength agents, permanent wet strength agents, bulk softening agents, lotions, silicones, wetting agents, latexes, patterned latexes and other types of additives suitable for inclusion in and/or on absorbent paper products.

“Machine Direction” or “MD” as used herein means the direction parallel to the flow of the fibrous structure through the fibrous structure making machine and/or absorbent paper product manufacturing equipment.

“Cross Machine Direction” or “CD” as used herein means the direction parallel to the width of the fibrous structure making machine and/or absorbent paper product manufacturing equipment and perpendicular to the machine direction.

“Ply” as used herein means an individual, integral fibrous structure.

“Plies” as used herein means two or more individual, integral fibrous structures disposed in a substantially contiguous, face-to-face relationship with one another, forming a multi-ply fibrous structure and/or multi-ply sanitary tissue product. It is also contemplated that an individual, integral fibrous structure can effectively form a multi-ply fibrous structure, for example, by being folded on itself.

As used herein, the articles “a” and “an” when used herein, for example, “an anionic surfactant” or “a fiber” is understood to mean one or more of the material that is claimed or described.

“Embossing” refers to a type of paper finish obtained by mechanically impressing a design on the finished paper with engraved rolls, plates, or belts in combination with complimentary or mating metallic, cross-linked rubber, or soft rubber or rubber-like rolls, or belts. Embossing is common in the papermaking industry, particularly in the manufacture of paper towels, toilet tissue, and the like.

“Printing” refers to a type of finish applied to the absorbent product that imparts colorful visually perceptible design. One or more colors can be applied mechanically by means commonly known in the art such as applying ink by a gravure roll, flexographic plates, or other known means. Printing is common in the papermaking industry, particularly in the manufacture of paper towels and the like

In an embodiment, the present invention is an absorbent paper product having at least one ply with an emboss pattern and/or print pattern comprising one or more visually distinct design elements disposed in a predetermined pattern. The absorbent paper product can be a facial tissue, bath tissue, paper towel, napkin, or the like, and can be provided in roll form, as is common for bath tissue and paper towels. The absorbent paper product can be single-ply or multi-ply.

The absorbent paper of the absorbent paper product can be any absorbent paper known for use as facial tissue, bath tissue, paper towel, napkin, or the like, and will not be described in detail herein. By way of example, absorbent paper products suitable for use in the present invention include the absorbent paper utilized in currently marketed facial tissues including PUFFS® and KLEENEX®, currently marketed bath tissues such as CHARMIN®, COTTONELLE®, ANGEL SOFT®, and QUILTED NORTHERN®, currently marketed paper towels such as BOUNTY®, VIVA®, and BRAWNY®. In general, any absorbent paper product made by known papermaking methods can be utilized in the present invention. Therefore, the description below is non-limiting with respect to the particular absorbent paper product to be embossed and/or printed on, the particular manufacturing method, or the particular format (e.g., rolled or stacked/interleaved).

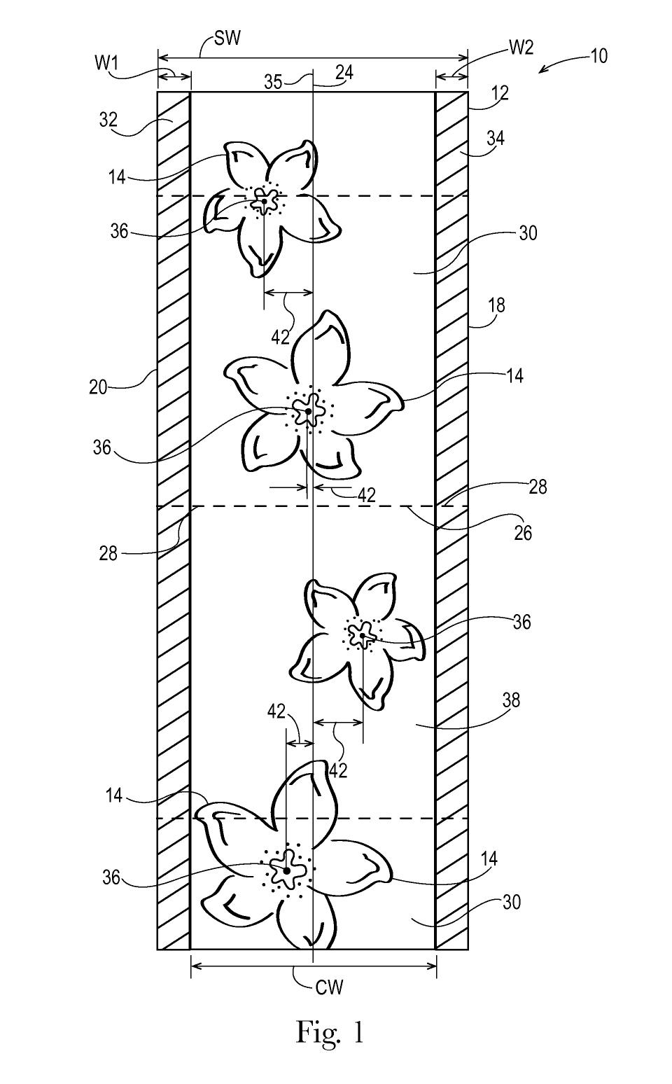

One embodiment of the invention is shown in FIG. 1, a plan view of a strip 12 of absorbent paper product 10. The absorbent paper product 10 shown in FIG. 1 can be manufactured by any process known in the art prior to being embossed and/or printed on with a pattern. The strip 12 can comprise a first edge 18 and a second edge 20, opposite the first edge 18. The first edge 18 and the second edge 20 of the strip 12 can be generally parallel and define a strip width SW therebetween. The strip width SW can be from about 15 inches to about 13 inches or from about 12 inches to about 11 inches or from about 10 inches to about 6 inches or from about 5 inches to about 3 inches, reciting, for each of the disclosed ranges, all 0.1 increments therebetween. The strip 12 further comprises a centerline 24 that extends in a longitudinal direction between the first edge 18 and the second edge 20. The longitudinal direction is substantially parallel to the machine direction MD. The centerline 24 is substantially equidistant between the first edge 18 and the second edge 20. Still further, the strip 12 can comprise one or more lines of weakness 26 comprising one or more perforations 28. The line of weakness 26 allows one or more sheets 38 to be separated from a rolled absorbent product.

A strip 12, which is a portion of a web, can comprise one or more regions, as illustrated in FIG. 1. In one embodiment, the strip 12 can comprise a central region 30. The central region 30 extends in the longitudinal direction and has a central width CW that is less than the strip width SW. The central width CW can be from about 97% to about 25% and/or from about 85% to about 40% and/or from about 75% to about 55% or about 70% of the strip width SW. For example, in one embodiment, the strip width SW can be equal to about 4 inches and the central width CW can be about 75% of the strip width SW, in which case the central width CW is equal to about 3 inches. The central region 30 can extend outward from the centerline 24. The central region 30 can extend an equal distance outward the centerline 24 or at an unequal distance about the centerline 24 of the strip 12, a shown in FIG. 1.

As previously stated, the central width CW can be less than strip width SW, thus, at least one of a first edge region 32 and a second edge region 34 extend outward from the central region 30, as shown in FIG. 1. The first edge region 32 and the second edge region 34 can extend from the central region 30 toward at least one of the first edge 18 and the second edge 20, respectively. In one embodiment, the first edge region 32 defines a first edge width W1 and the second edge region defines a second edge width W2. The first edge width W1 can be equal to, less than, or greater than the second edge width W2. The first edge width W1 and the second edge width W2 can be dependent on the central width CW and the placement of the central region 30 with respect to the strip width SW. In one example embodiment, the first edge width W1 can be substantially equal to zero and the second edge width W2 can be substantially equal to the difference between the strip width SW and the central width CW. The first edge width W1 and the second edge width W2 generally add up to the difference between the strip width SW and the central width CW. For example, in one embodiment, the strip width SW is about 4 inches and the central width is about 3 inches; thus, assuming the central region 30 is equidistant about the centerline 24, the first edge region 32 would have a first edge width W1 of about one-half inch and the second edge region 34 would have a second edge width W2 of about one-half inch.

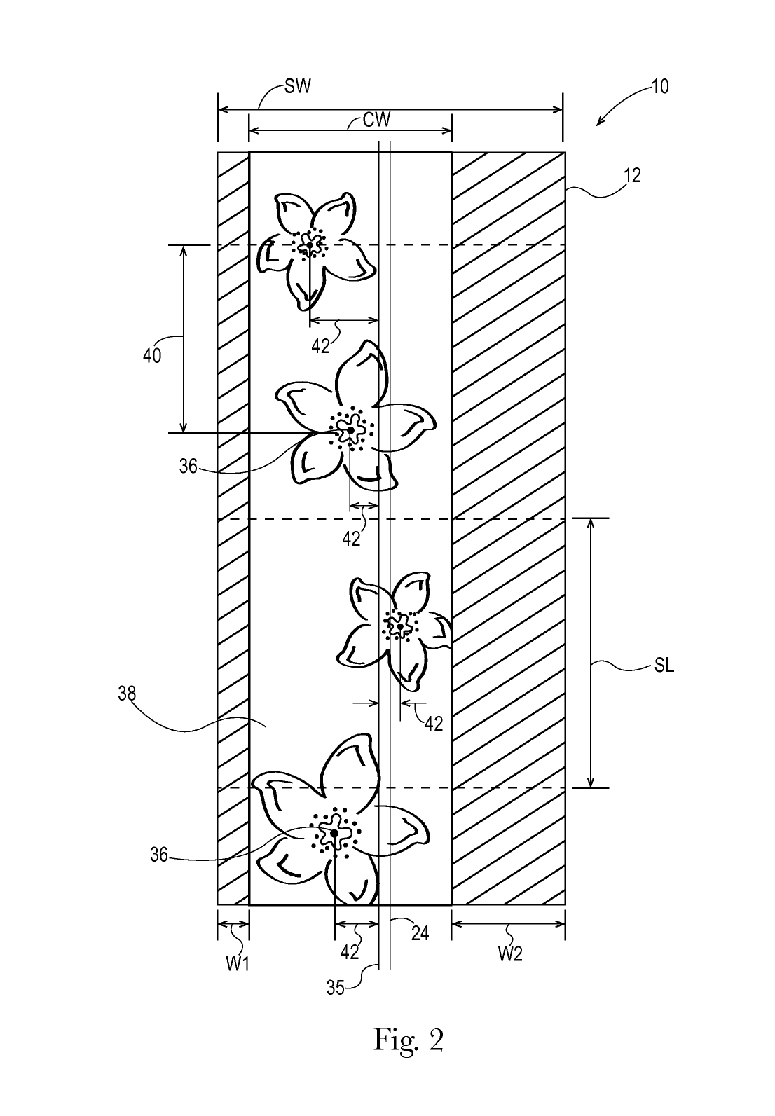

Still referring to FIG. 1, the absorbent paper product 10 can further comprise a first design element 14 disposed within the central region 30. One or more first design elements 14 can comprise a pattern, such as that shown only as a representation in FIG. 1, which can repeat in the machine direction. A pattern can be one or more first design elements 14 designed to span from about three sheets to about six sheets or greater than about seven sheets of absorbent paper product 10. The pattern can then repeat over the adjacent span of about three sheets to about six sheets or greater than about seven sheets of absorbent paper product 10. A first design element 14 can include any shape, design, or combination of shapes and designs, and can be included with other design elements, as will be discussed in more detail below. The first design element 14 can be disposed between the first edge 18 and the second edge 20 of the strip 12. More specifically, the first design element 14 can be disposed within the central region 30 and/or between at least one of a first edge region 32 and a second edge region 34. Generally, the central region 30 can be a predetermined region that encompasses each of the first design elements 14 within a pattern. Stated another way, each outer boundary of the central region 30 extends longitudinally, in the MD, along each side of the pattern of one or more first design elements 14 and does not cut-off any portion of the one or more first design elements 14. The pattern of one or more first design elements 14 can have a pattern centerline 35 that extends longitudinally along the center of the one or more first design elements 14, as shown in FIGS. 1 and 2. The central region 30 can be disposed on the strip 12 such that the pattern centerline 35 and the strip centerline 24 are in the same position, as shown in FIG. 1. In another embodiment, the central region 30 can be disposed on the strip such that the pattern centerline 35 is at a position other than the strip centerline 24, as shown in FIG. 2, and discussed more fully herein.

As previously stated, in one embodiment, the first design element 14 can be substantially disposed within the central region 30 and about and/or on the pattern centerline 35, as shown in FIGS. 1 and 2. Each first design element 14 can comprise a visual center point 36. The visual center point 36 of the first design element can be a point that a consumer would visually identify as being the central focal point of the design. For example, the first design element 14, shown in FIGS. 1 and 2, can have a visual center point 36, which is the central focal point of the flower design. One such theory that could be used to describe how an individual would perceive and classify the parts of a visual element is known as Gestalt psychology. One theory within Gestalt psychology indicates that the mind perceives objects as being symmetrical and forming around a center point, which in the instant disclosure is referred to as the visual center point 36. In one embodiment, the visual center point 36 may be indicated by an emboss design and/or print design. In another embodiment, the visual center point 36 can be identified as the lack of an emboss design and/or print design, as shown in FIG. 1 for example. Human beings have an instinctive affinity for symmetry.

Alternatively, if the first design element 14 does not have visual center point 36 that can be readily identified by a consumer, the visual center point 36 can be estimated. The visual center point 36 of a first design element 14 can be estimated by drawing a first line that is substantially perpendicular to the centerline 24 and through the midpoint of the height of the first design element 14 and then drawing a second line substantially parallel to the centerline 24 and through the midpoint of the width of the first design element 14. The point at which the first line and the second line cross can be identified as the visual center point 36. Further to the above, the height of the first design element can be the two farthest, opposing points from one another in the longitudinal direction, substantially parallel to the MD. The width of the first design element 14 can be the two farthest, opposing points from one another in the direction substantially perpendicular to the longitudinal direction.

As previously disclosed, each first design element 14 can comprise a visual center point 36. The visual center point 36 can be offset 42 a certain distance from the pattern centerline 35 extending in the machine direction MD. The offset 42 can be measured perpendicularly to the pattern centerline 35. The offset 42 for an individual first design element 14 to the pattern centerline 35 can be less than about the strip width SW to zero and/or about one-half the strip width SW to zero. For example, in one embodiment, the visual center point 36 of a first design element 14 can be disposed on the pattern centerline 35 and have an offset 42 substantially equal to zero. As previously stated, one or more first design elements 14 that are designed to span three to six sheets of absorbent paper product 10 can be a pattern. Each of the first design elements 14 in a pattern can be strategically placed about the pattern centerline 35 such that the sum of the distances of each offset 42 of each first design element 14 to the left of the pattern centerline 35 is substantially equal to the sum of the distances of each offset 42 of each first design element 14 to the right of the pattern centerline 35 (left and right being with respect to the view shown in FIGS. 1 and 2; stated another way, the description can also be with respect to “one side” and “the opposite side” of a centerline). For example, if the pattern comprised four first design elements 14, two being to the left of the pattern centerline and two being to the right of the pattern centerline, the sum of the offsets 42 of each of the first design elements to the left of the pattern centerline 35 would be substantially equal to the sum of the offsets 42 of the first design elements to the right of the pattern centerline 35.

Stated another way, assuming that the offset of each first design element 14 placed to one side of the pattern centerline 35 is assigned a positive distance and the offset of each first design element 14 placed to the opposite side of the pattern centerline 35 is assigned a negative distance, the sum of each offset 42 of each first design element 14 in a pattern will be equal to substantially zero. Substantially refers to numerical values being within less than about 10% of one another. Thus, the visual center points 36 of the one or more of first design elements 14 within a given pattern can be substantially balanced about the pattern centerline 35. This visual trickery creates the illusion of registration of the pattern of one or more first design elements 14 for a given number of sheets 38. Having a pattern of one or more first design elements 14 be balanced about the pattern centerline 35 allows manufacturers to provide to consumers an absorbent paper product comprising a pattern that is perceived to be registered, which consumers desire. Registration refers to a centered design, such as a pattern, on a strip 12. For example, a registered design can be one that the pattern centerline 35 coincides with the centerline 24 of strip 12. Consumers are drawn to the pattern centerline 35 of the one or more first design elements 14 making it difficult to readily recognize the centerline 24 of the strip 12. This visual trickery allows manufactures to produce products that are acceptable to consumers and account for variations in the manufacturing process. Achieving a completely registered design that is perceived by consumers to be accurately registered is very difficult for manufacturers. The production of absorbent paper products is often done at high speeds and on manufacturing equipment that was not designed for precise placement of design elements. The present disclosure solves this problem by providing a pattern that visually tricks the consumer into perceiving a registered pattern.

For example, in one embodiment, the pattern can comprise a plurality of first design elements 14 disposed about the pattern centerline 35. Each of the first design elements 14 can comprise a visual center point 36. The plurality of first design elements 14 are disposed about the pattern centerline 35 such that the sum of offsets 42 of the visual center points 36 of each first design element 14 disposed to one side of the pattern centerline 35 is about equal to the sum of offsets 42 of the visual center points 36 of each first design element 14 disposed to the opposite side of the pattern centerline 35, and the pattern of first design elements 14 can be disposed within a central region 30 of the strip 12 having a central width CW, which is less than the strip width SW. The pattern comprising the plurality of first design elements 14 can be imparted on to the strip 12 such that the pattern is disposed between the first edge 18 and the second edge 20 of the strip 12. The central region 30 extends laterally outward on each side of the centerline 24 of the strip 12 such that at least about 25% of the central width CW is positioned to one side of the centerline 24. The placement of the pattern on the strip 12 in accordance with the above disclosure allows for a consumer acceptable pattern of individual elements. Further, the above disclosure achieves an impression of acceptable perceived registration about a centerline in the machine direction that can actually deviate from the centerline 24 of the strip 12 of absorbent paper product 10.

As stated above, the first design elements 14 in a pattern can be strategically placed about the pattern centerline 35. The strategic placement of the one or more first design elements 14 can lead to a pattern that consumers perceive as being symmetrical about the pattern centerline 35 and registered to the absorbent paper product, when in fact the pattern may not be symmetrical with respect to the centerline 24 of the strip 12. The present disclosure is not important for random patterns and those small repeating patterns that span the entire length and width of the sheet. The present disclosure plays on the consumer's instinctive affinity for symmetry by providing a strategically placed pattern of one or more first design elements 14 that can be perceived to be registered about the centerline 24 on one or more sheets of absorbent paper product.

Referring to FIG. 2, each of the one or more first design elements 14 comprises a visual center point 36. The visual center points 36 of two adjacent first design elements 14 can be some longitudinal distance 40 from one another. The longitudinal distance 40 between adjacent first design elements 14 can be substantially the same or different. The longitudinal distance 40 is said to be substantially the same if the longitudinal distance 40 between adjacent elements is within about 10% of the distance of other adjacent elements. The longitudinal distance 40 between the visual center points 36 of adjacent first design elements 14 can be less than about the sheet length SL of one sheet 38. The length SL of a sheet 38 is the distance between adjacent lines of weakness 26 measured along a first edge 18 or second edge 20. In another embodiment, the longitudinal distance 40 can be from about 1.5 inches to about 10 inches, including all 0.25 inches in the recited range. In another embodiment the longitudinal distance 40 between the visual center points 36 of adjacent first design elements 14 can be such that there is about three-fourths of one first design element 14 per sheet 38 and/or one first design element 14 per sheet 38 and/or about 1.5 first design elements 14 per sheet 38 and/or about 2 first design elements 14 per sheet 38 and/or greater than about 3 first design elements 14 per sheet 38 and/or less than about eight first design elements 14 per sheet 38.

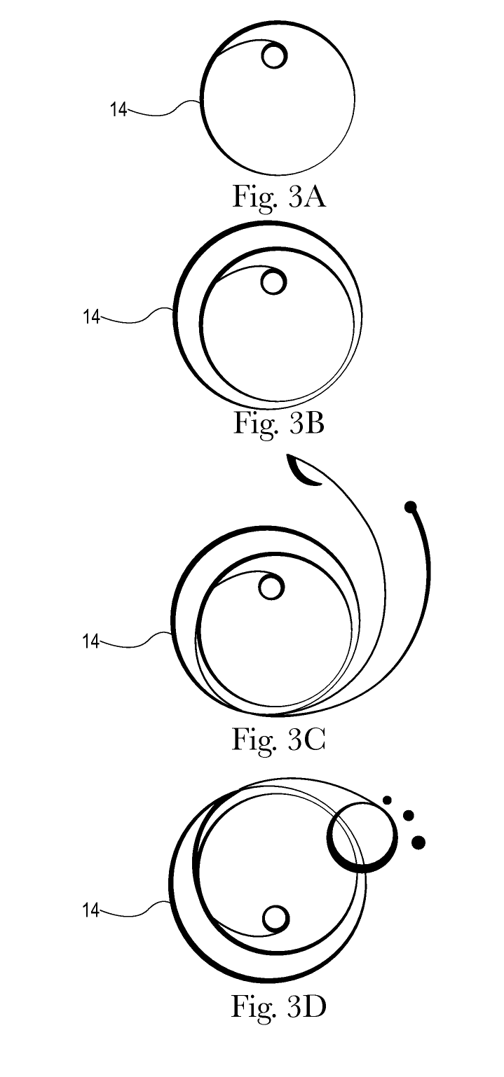

As previously disclosed, the first design element 14 can include any shape, design, or combination of shapes and designs. FIGS. 3A-3D illustrate other example embodiments of a first design element 14 according to the present disclosure. As shown in FIG. 3C, a first design element 14 can comprise features that extend from a main circular portion of the design element. Further, as shown in FIG. 3D, a first design element 14 can comprise features that are unattached from the main portion of the design element.

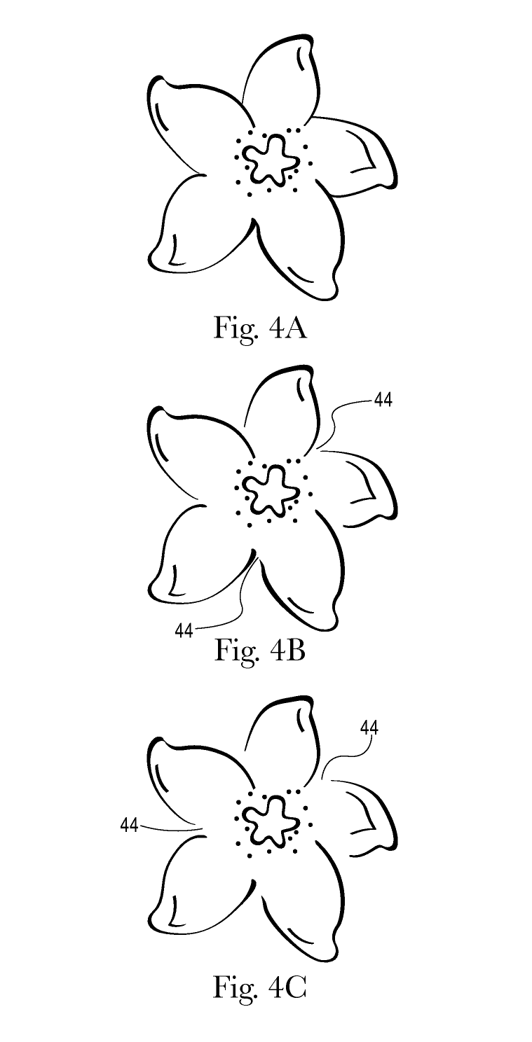

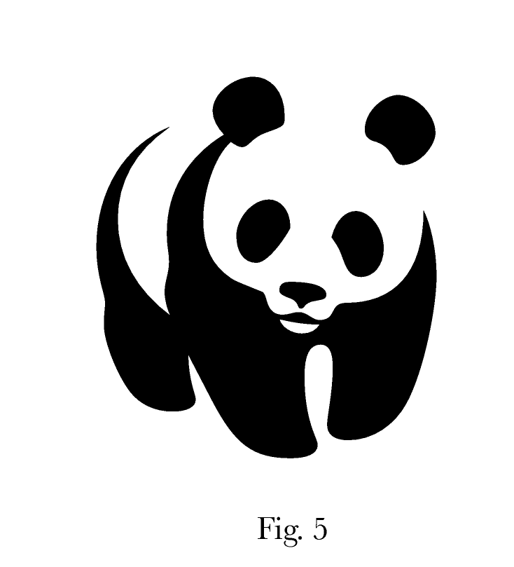

FIGS. 4A-4C illustrate other example embodiments of the first design element 14. A first design element 14 can be substantially closed in that the design lacks any gaps 44 about an outer perimeter, as shown in FIG. 4A. Likewise, a first design element 14 can comprise a design that contains one or more gaps 44 between lines or other design features about an outer perimeter, as shown in FIGS. 4B and 4C. In comparing the first design elements 14 of FIGS. 4B and 4C, the gaps 44 can be of varying size. One of ordinary skill in the art would recognize that despite the difference in the size of the gaps 44 in each of FIGS. 4B and 4C, the general pattern of a flower would still be identified by a consumer. This again relates back to Gestalt psychology and its theories of visual perception. One of these theories is closure. Closure occurs when there is enough of a shape present that a person is able to mentally complete the shape so as to perceive a broken figure as a whole. This concept is illustrated in FIG. 5 in which a drawing of a panda is shown. Despite the “panda” being represented by unconnected shapes in close proximity, a person could perceive a panda as being complete because he or she is able to mentally complete the shape.

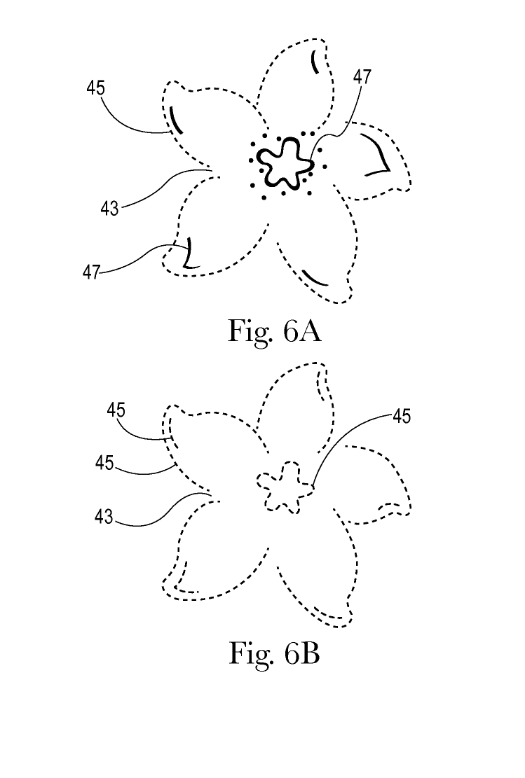

In view of the aforementioned, FIGS. 6A and 6B illustrate yet other example embodiments of the first design element 14. The first design element 14 can comprise one or more broken elements 45 and/or one or more solid elements 47 and/or one or more gaps 43. However, despite the change in design of the elements and gaps comprising the first design element 14 a consumer could identify the first design element as a flower. As such, a series of unconnected points or line elements, or other shapes that are perceived by a consumer as a complete, identifiable shape, can be a first design element 14.

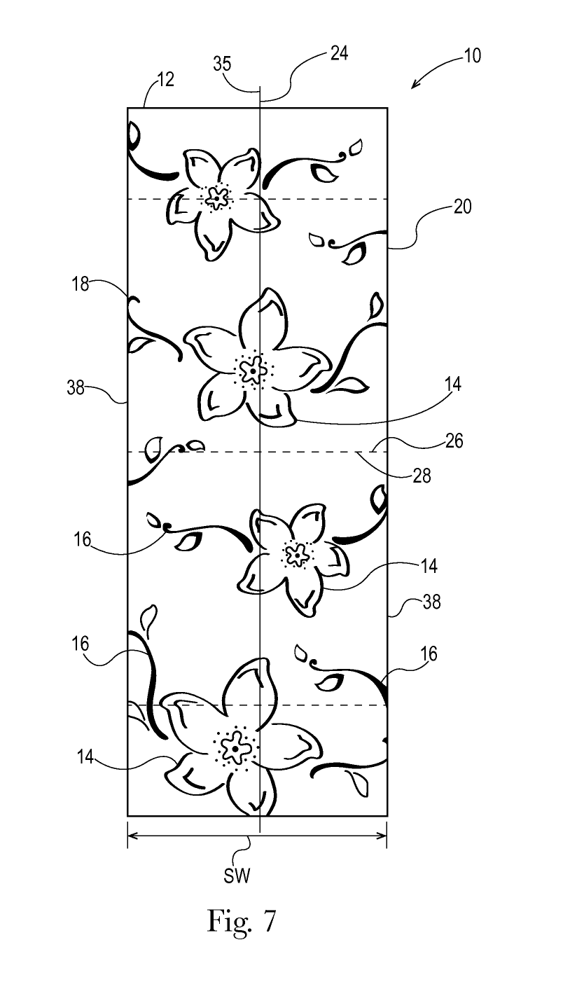

In another example embodiment, referring to FIG. 7, the absorbent paper product 10 can have at least two visually distinct design elements, a first design element 14, which in FIG. 7 includes, for example a flower, and a second design element 16, which in FIG. 7 is in the form of an extended, generally linear or curvilinear element. First design element 14 can include any shape, design, or combination of shapes and designs (as previously disclosed) and can be included with other design elements. For example, the first design element 14 can be present on a strip 12 with a second design element 16 and/or a third design element and/or a fourth design element (not shown). A third and fourth design element can be any shape or size that is similar to the second design element 16 and distinct from the first design element 14 in at least one of size and shape.

The second design element 16 can include any shape, design, or combination of shapes and designs. However, the first design element 14 can be visually distinct from the second design element 16. For example, the first design element can be a relatively large, open, two-dimensional geometric or decorative shape, compared to a second design element 16 that can be a relatively thin, wavy, curvilinear shape. In general, visually distinct design elements are design elements that can be visually distinguished as discrete, separate design elements based on overall size and shape. For illustration purposes, a first design element 14 can comprise a flower and a second design element 16 can comprise a vine-like appearance, and these two design elements could be considered visually distinguishable. Similarly, against for purposes of illustration, the first design element 14 can generally comprise an circle and a second design element 16 can comprise a circle that is about one-fourth the size of the first design element 14, and these two design elements could be considered visually distinguishable.

In one embodiment, the area of the first design element 14 can be at least about three times larger than the area of the second design element 16. One of ordinary skill in the art would recognize that an area of the design element could be determined by utilizing a visual image and a computing system to mathematically calculate the area. As shown in FIG. 7, the first design element 14, a flower, is visually distinct from the second design element 16, a linear element, in both size and shape. For example, the area of a second design element 16, shown in FIG. 7 as a linear element, can be the length multiplied by the average width of the design element. The design elements disclosed herein are representative only, and virtually any design element can be utilized for either the first or second design elements.

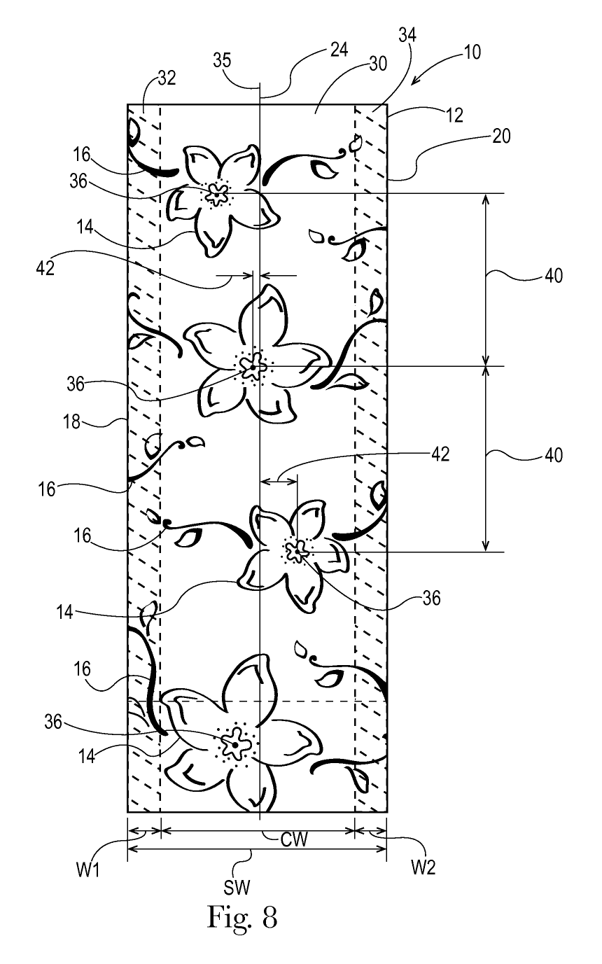

Still referring to FIG. 7, the first design element 14 can be disposed between the first edge 18 and the second edge 20, and more specifically, between at least one of the first edge region 32 and the second edge 34 (as shown in FIG. 8). The second design element 16 can be disposed between the first edge 18 and the second edge 20 or can extend to, and be, in effect, cut off at, at least one of the first edge 18 and the second edge 20. As previously disclosed, the second design element 16 can be embossed and/or printed on the absorbent paper product 10. In one embodiment, an embossed second design element 16 can aid in binding one or more plies of absorbent paper product 10, particularly at the edges. Binding the edges of one or plies of absorbent paper product 10 can help prevent ply delamination, which can be the separation of plies during use. In one example embodiment, a second design element 16 extends to and, in effect, is cut off at, at least one of the first edge 18 and the second edge 20 within a sheet 38. In another example embodiment, two second design elements 16 extends to and, in effect, are cut off at, at least one of the first edge 18 and the second edge 20 within a sheet 38. The placement of the design elements will be discussed in more detail below.

Referring to FIG. 8, in one embodiment, at least one of the second design elements 16 can be substantially disposed within the central region 30. A second design element can be substantially disposed within the central region when less than about 10% of the area of the second design element 16 extends into at least one of the first edge region 32 and the second edge region 34. Further, in one embodiment, at least one second design element 16 can extend between the central region 30 and at least one of the first edge region 32 and the second edge region 34. In yet another embodiment, at least one second design element 16 can be disposed in the central region 30, at least one of the first edge region 32 and the second edge region 34, and extend to and be, in effect, cut off by at least one of the first edge 18 and the second edge 20. More specifically, a portion of at least one second design element 16 can be disposed in the central region 30 and another portion of the at least one second design element 16 can be disposed in at least one of the first edge region 32 and the second edge region 34. For example, in one embodiment, a second design element 16 can originate in the central region 30, extend across the second edge region 34, and extend to and be, in effect, cut off at the second edge 20 of the strip 12. In yet another embodiment, the second design element 16 can be connected to the first design element 14. The second design element 16 aids in the visual trickery by filling in the empty space of the absorbent paper product. Thus, when the pattern centerline 35 deviates from the centerline 24 of the strip 12, the second design elements 14 draw the consumers eye back to the pattern centerline 35 and provide additional design details on at least one of the first edge region 32 and the second edge region 34 such that these regions cannot be readily identified by the consumer. Therefore, the second design elements 14 aid in the impression of perceived consumer-acceptable registration along the centerline 24 even if registration actually deviates from the centerline 24 of the strip 12.

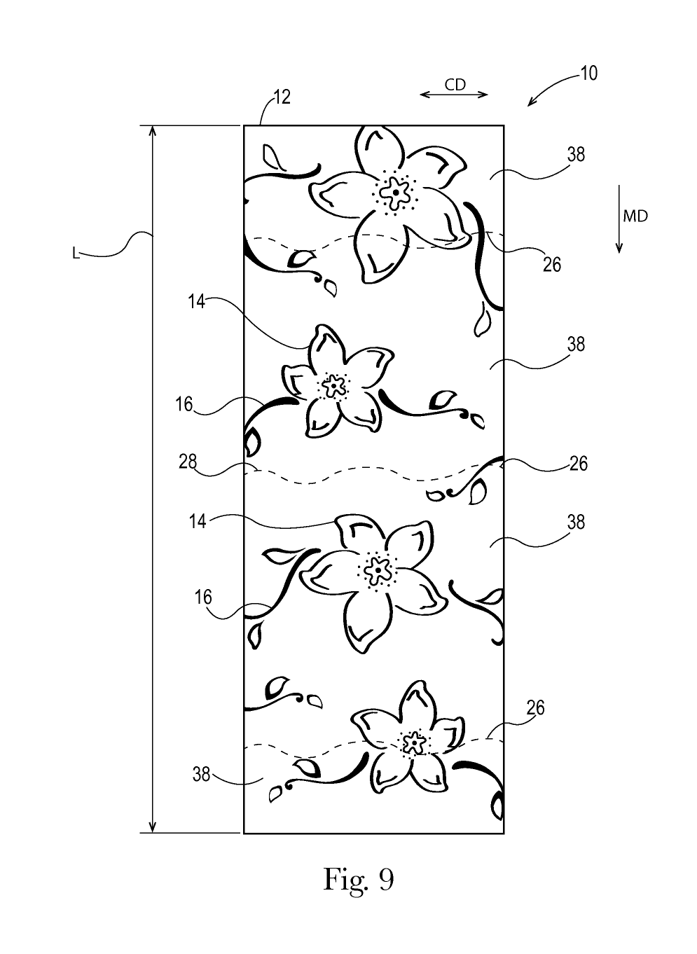

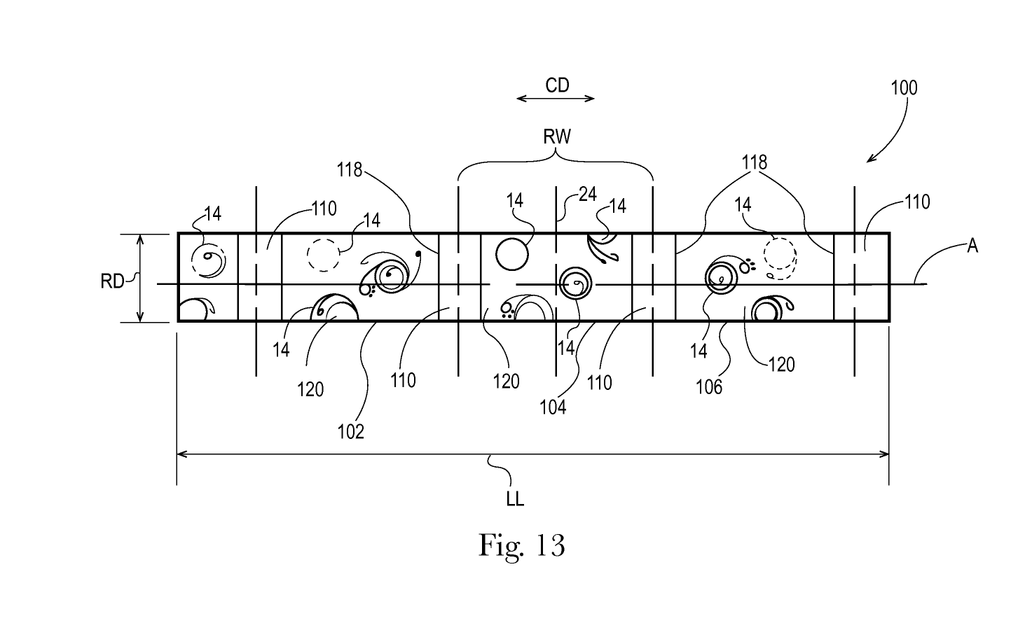

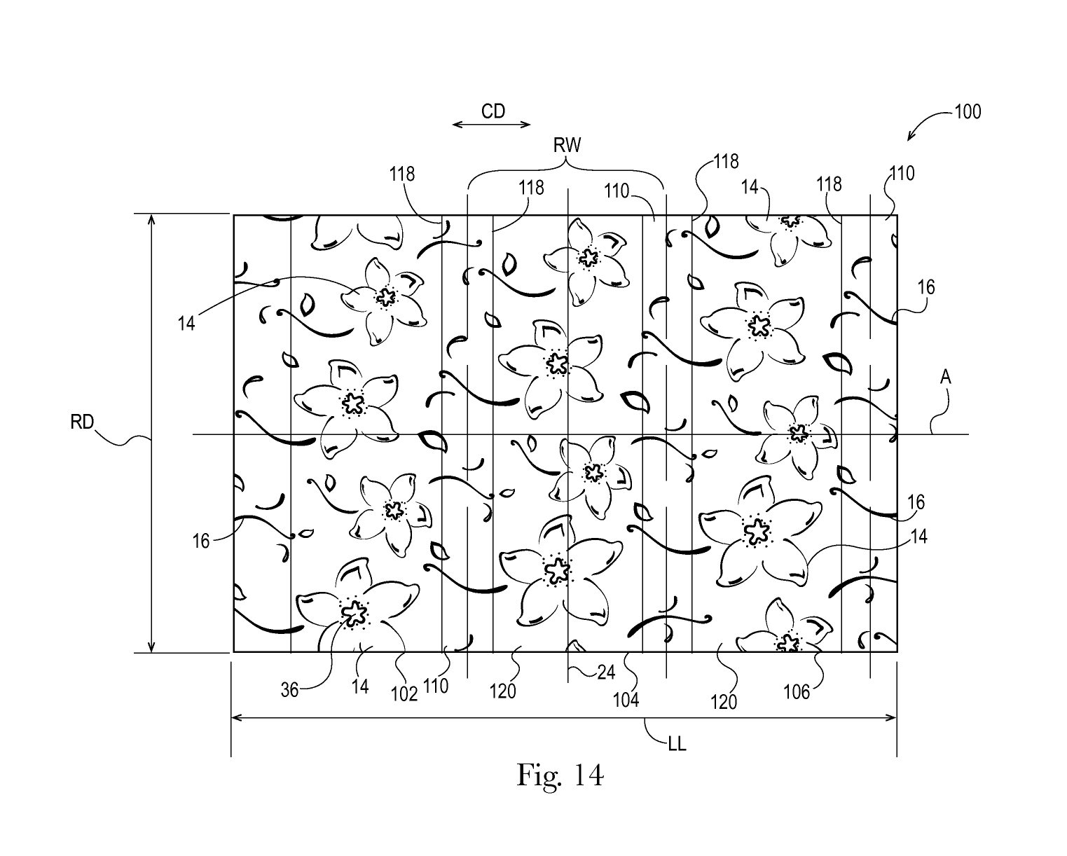

FIG. 9 shows a portion of a web of absorbent paper product 12 having a length L. Absorbent paper product 12 can be made on papermaking machines, which as is known in commercial operations produces parent rolls of absorbent paper product having a machine direction MD and a cross direction CD. The MD represents the direction of travel as the absorbent paper product is being made on the paper machine. The CD represents the cross direction, which at its maximum is the width of the web of paper as it is being made (or the width of a finished paper product, such as a paper towel). Absorbent paper product 12 can comprise spaced apart lines of weakness 26, which can be in the form of one or more perforations 28, which in the finished product facilitate tearing off one sheet at a time. For example, rolled absorbent paper products, such as bath tissue and paper towels typically have one or more perforations that permit the user to tear off a sheet (or a plurality of sheets) at the location of the perforation. Additionally, the parent roll can be rolled into “logs”, shown in FIGS. 13 and 14, which are rolls having a smaller diameter and number of sheets desired for the finished product. Logs can be cut by a log saw, not shown, to produce a plurality of finished rolls of a predetermined width. Each sheet 38 is defined in the CD by the settings of the log saw which cuts the log, and in the MD by the spacing of lines of weakness 24.

FIG. 9 illustrates two full sheets 38 of absorbent paper product and two partial sheets 38 of absorbent paper product that can be dispensed from a finished roll. An absorbent paper product can comprise a first design element 14 and a second design element 16 disposed in a pattern that repeats. In one embodiment, a pattern of one or more first design elements 14 and one or more second design elements 16 can be designed to cover about 4 sheets 38 or about 5 sheets or about 6 sheets or greater than about 7 sheets. Thus, in an embodiment, the pattern of one or more first design elements 14 and second design elements 16 does not repeat until about 4 to about 6 sheets are dispensed from the finished rolled absorbent paper product. Alternatively, the pattern can be designed such that when the absorbent paper product is rolled and prior to being dispensed, the pattern about the circumference of the roll would not repeat. Similar to the above, it could be found that the average consumer dispenses an average number of sheets 38 of rolled absorbent product per use and, therefore, a pattern can be designed such that when the consumer dispenses the average number of sheets of absorbent product, the consumer does not perceive that the pattern of one or more first design elements 14 and one or more second design elements 16 repeats.

As previously stated, consumers desire a design that is perceived to be centered, that is registered, relative to edges 18 and 20. Accordingly, the pattern of the present disclosure created by one or more first design elements 16 and one or more second design elements 16 can be perceived as being centered along or about the centerline 24 of strip 12. In one embodiment, for a length L of strip 12 having three or more first design elements 14, at least one visual center point 36 of a first design element 14 on the strip 14 does not fall on the centerline 24 of the strip 12. The visual center point 36 of each first design element 14 on a strip 12 can be positioned on either side of the centerline 24 of the strip 12 or on the centerline 24 of the strip 12 thus making it difficult for a consumer looking at the strip 12 to identify the exact centerline 24 of the strip 12. Further, the visual center point 36 of each first design element 14 positioned about a pattern centerline 35 can draw the consumer's attention to the pattern centerline 35 as opposed to the exact centerline 24 of the strip 12. In an embodiment, the visual center points 36 of a plurality of first design elements 14 within a given length can be balanced; that is, the offset 42 of each first design element 14 from pattern centerline 35 can be summed to substantially zero, as previously disclosed. This visual trickery creates the illusion of registration of the pattern of design elements for a given length L of strip 12. Registration refers to a completely centered design on the strip 12. Thus, manufacturers can produce an absorbent paper product with one or more design elements that appear to a consumer to be registered about the centerline 24, but for which each design element is in fact some distance off the centerline 24 of the strip.

In one example embodiment, a pattern can comprise a plurality of first design elements 14 and a plurality of second design elements 16. Each first design elements 14 comprises a visual center point 36. The plurality of first design elements 14 are disposed about the pattern centerline 35 such that the sum of offsets 42 of the visual center points 36 of each first design elements 14 disposed to one side of the pattern centerline 35 is about equal to the sum of offsets 42 of the visual center points 36 of each first design element 14 disposed to the opposite side of the pattern centerline 35. Further, the pattern of first design elements 14 can be disposed within the central region 30 having a central width CW, which is less than the strip width SW. The plurality of second design elements 16 can be disposed in the central region 30 and/or extend over the central region 30. The pattern comprising the plurality of first design elements 14 and plurality of second design elements 16 can be imparted onto the strip 12 such that the central region 30 extends laterally outward on each side of the centerline 24 of the strip 12, and at least about 10% of the central width CW is positioned to one side of the centerline 24 of the strip 12.

In one example embodiment, a strip 12 having a strip width of about 4 inches, a central region 30 having a central width CW of about three inches about the centerline 24, a first edge region 32, and a second edge region 34, could have a visual appearance of being centered, when in fact, the pattern centerline 35 is shifted as much as about one-half inch to either side of centerline 24 such that the first edge region 32 would have a first edge width W1 of about 0 to about 1 inch and the second edge region 34 would have a second edge width W2 of about 0 to about 1 inch. Despite the shift of the central region 30 about the centerline 24 of the strip 12, a consumer can still perceive the pattern of first design elements 14 as being substantially centered, also referred to as registered.

In accordance with the above description, first design element 14 and second design elements 16 can be varied for a desired visual impression by the manufacturer or marketer of the absorbent paper product. However, for absorbent paper products 10 of the present disclosure, in an embodiment, the placement of the design elements can be sufficient to ensure that at least one of the first design elements 14 and the second design element 16 at least partially intersects with a line of weakness 26, as shown in FIG. 9 (the uppermost and lowermost first design elements 14). An advantage of producing an absorbent paper product in which at least one of the first design elements 14 and the second design elements 16 intersects one or more lines of weakness 26 is again to improve consumer perception of the absorbent paper product. When the consumer visualizes the rolled absorbent product in a dispensing position or purchasing position, the design elements can aid in the product appearing as one seamless product having a centrally-disposed flow of visual imagery. Further, another advantage of having at least one of the first design elements 14 and the second design elements 16 cross one or more lines of weakness 26 is to improve the bond between multiple plies of absorbent sheet product. For example, this can aid in preventing debonding of plies.

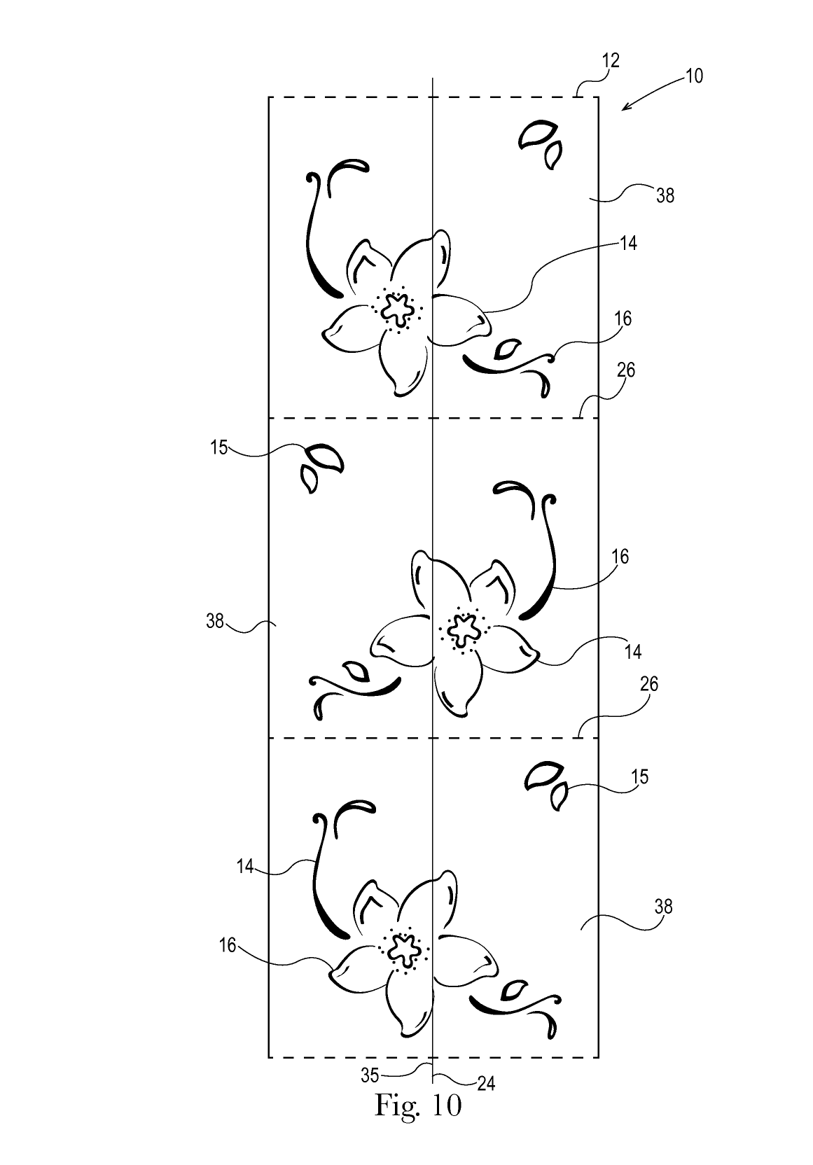

Alternatively, in one embodiment, as shown in FIG. 10, a pattern can be designed such that neither the first design element 14 nor the second design element 16 crosses a line of weakness 26. When a consumer is using such bath tissue, for example, and reaches to tear off one sheet, the user's eyes are drawn to the roll of bath tissue, and specifically can be drawn to the line of weakness 26 at which the tear propagates. The point at which the first design element 14 and/or the second design element 14 discontinues aids in the consumer identifying the line of weakness 26 on which the consumer can grasp and tear the product. Further, in another embodiment, the pattern can comprise additional design elements that can aid in bonding one or more plies of absorbent paper product, and or to aid in identification of a single sheet of absorbent paper product. For example, as shown in FIG. 10, an additional third design element 15 is illustrated opposite the first design element 14.

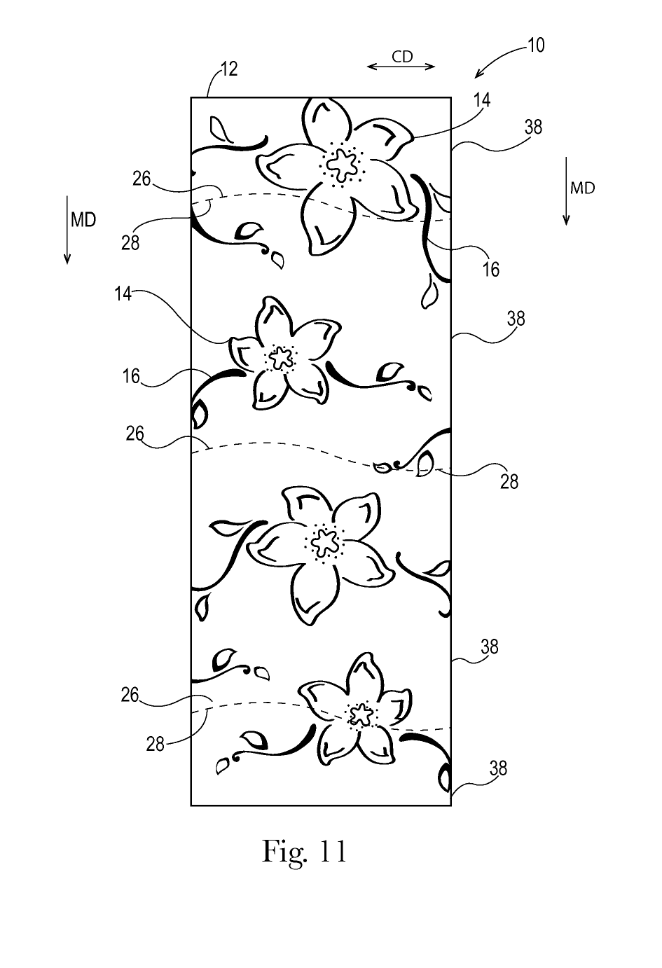

The line of weakness 26 can be linear or curvilinear shape, as shown in FIGS. 9-11. The line of weakness 26 comprises one or more perforations 28 that can be positioned to give some shape to the line of weakness 26, such as a straight line or a wavy path. The line of weakness 26 can be shaped to complement the pattern of one or more first design elements 14 and/or one or more second design elements 16. As shown in FIGS. 9 and 11, the line of weakness 26 can be generally a sinusoidal-like wave shape. This sinusoidal-like wave shape can complement either one of the first design elements 14 or second design elements 16, such as the whimsical line shape of the second design element 16 and the generally curvilinear shape of flower petals of the first design elements 14, as illustrated in FIG. 9. Similar to the above, FIG. 11 shows another shaped line of weakness 26 that, due to its gentle curvature, also complements the first design element 14 and the second design element 16 of the pattern. Thus, for a given pattern one or more lines of weakness 26 having different shapes can be said to complement the first design element 14 and/or the second design element 16.

Further to the above, the shape of the line of weakness 26 can be designed for ease of consumer dispensing. For example, a sinusoidal-like shape line of weakness 26 may be more easily dispensed than a triangular-like, i.e., “zig-zag” shape line of weakness 26 (not shown).

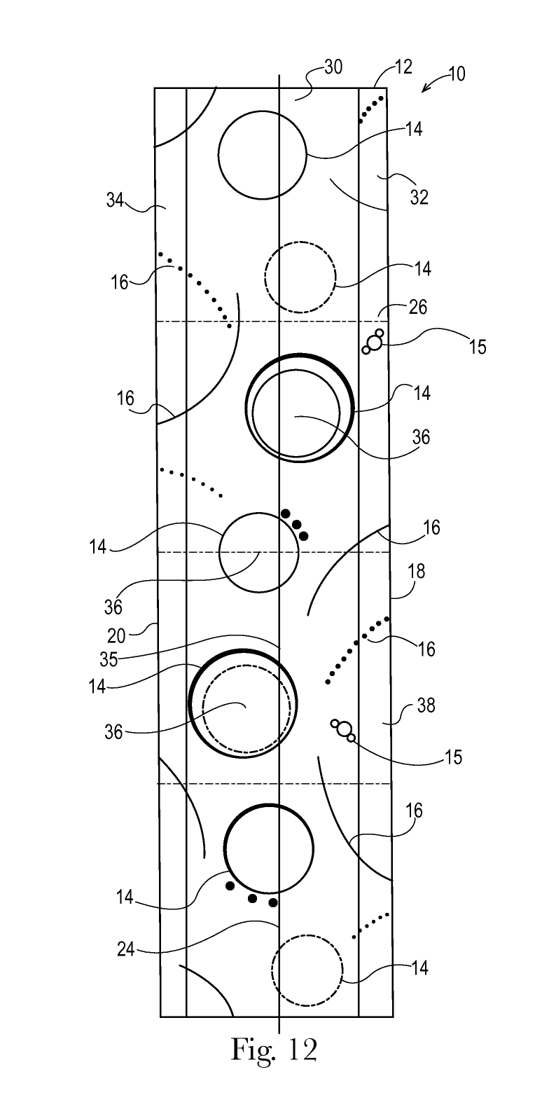

FIG. 12 illustrates another example embodiment of the present disclosure. A pattern can comprise one or more first design elements 14 and one or more second design elements 16 and one or more third design elements 15. The one or more first design elements 14 can include similar shapes that are slightly different in design. For example, as shown in FIG. 12, each of the first design elements 14 are generally circular in shape. However, one of the first design elements 14 can differ with respect to another first design element in that it has an additional circular element or comprises a dashed linear element. A first design element 14 can differ with respect to another first design element 14 as long as a consumer would perceive the first design elements 14 in a pattern as being related, such as being substantially the same shape or substantially the same size.

Still referring to FIG. 12, the pattern comprises one or more second design elements 16. Similar to the above, the one or more second design elements 16 can include similar shapes that are slightly different in design. For example, as shown in FIG. 12, each of the second design elements 14 are generally linear in shape. However, one of the second design elements 16 can differ with respect to another second design element in that the linear element is dashed, that is non-continuous. A second design element 16 can differ with respect to another second design element 14 as long as a consumer would perceive the second design elements 16 in a pattern as being related, such as being substantially the same shape or substantially the same size. Still referring to FIG. 12, in one embodiment, the pattern comprises one or more third design elements 15. Similar to the above, the one or more third design elements 16 can include similar shapes or words that are slightly different in design. For example, as shown in FIG. 12, each of the third design elements 15 are generally circular in shape. However, one of the third design elements 15 can differ with respect to another third design element 15 in that the element is dashed, that is non-continuous (not shown). A third design element 15 can differ with respect to another third design element 15 as long as a consumer would perceive the third design elements 16 in a pattern as being related, such as being substantially the same shape or substantially the same size or communicating substantially the same thing. For example, in one example embodiment, the third design element 15 can comprise a word such as a brand name or logo. More specifically, the third design element 15 can be any word such as CHARMINO, “soft,” or “strong.” Similarly, the third design element 15 can be any image such as that of an animal, an angel, or a human.

Referring to FIGS. 13 and 14, the absorbent paper product can be manufactured from a rolled web 100, referred to as a log. The rolled web 100 has an axis A about which is a rolled quantity of fibrous structure, from which the absorbent paper product is produced. The rolled web is suitable for cutting into shorter rolls and sold for use as absorbent consumer paper products such as paper towels or bath tissue. Prior to being cut and rolled, the web would be converted. Conversion includes printing and/or embossing one or more first design elements 14 and one or more second design elements 16 as previously disclosed.

The rolled web 100 can have a roll diameter RD of between about 3 inches to about 8 inches. The rolled web 100 can have a log 100 length LL of between about 80 inches to about 120 inches, or about 98 inches to about 102 inches, or up to about 150 inches. The fibrous structure, which can be bath tissue, of the rolled web 100 can comprise the pattern of one or more first design elements 14 and one or more second design elements 16 as disclosed above with respect to FIGS. 1-2 and 7-9. The one or more first design elements 14 can form a first repeating pattern disposed within a first zone 120 of rolled web 100, which corresponds to the central region 30 of the strip 12, shown in FIGS. 1-2 and 7-9. Likewise, the one or more second design elements 16 can form a second pattern disposed within second zone 110. The pattern disposed within second zone 110 corresponds to the one or more second design elements 16 disposed in the first edge region 32 and second edge region 34, as shown in FIGS. 7-9. Further, as previously disclosed, the repeating pattern disposed within the second zone 110 can extend into the first zone 120. Second zone 110 is the zone that can be cut by a log saw to produce finished rolls, and which corresponds to the first and second edge regions, 32 and 34, of strip 12. Thus, the rolled web 100 can comprise at least two second zones 110 separated by a first zone 120. The first zone 120 is visually distinct from the second zone 110 in that the second zone 110 can be free of any first design elements 14. The rolled web 100 can comprise visually distinct bands of design elements in the CD across the width of the log. The first zone 120 can be wider than the second zone 110. The second zone 110 can be indicated by borders 118. These borders 118 delineate the zone 110 in which the log saw should cut the log. Ideally, the log saw would cut the log at the center line of the second zone 110 between the borders 118. Two adjacent cuts define a roll width RW, which corresponds to the strip width SW, as shown in FIG. 1. By cutting the log between the borders 118, the finished absorbent product can comprise a first design element 16 disposed on a central region 30 and a second design element 16 disposed in at least the first edge region 32 and the second edge region 34, and that can extend to, and be, in effect, cut off at the first edge 18 or the second edge 20. As shown in FIGS. 13 and 14, the rolled web 100 can produce a number of individual rolls 102, 104, and 106. One of ordinary skill in the art would understand that the number of rolls produced from a rolled web 100 would depend in part on the desired roll width RW and the log length LL.

As can be understood in light of the above disclosure, the second zone 110 allows for some variation in cutting the log; that is, the log does not have to be cut in the exact center of the second zone 110 for a consumer to perceive the first repeating pattern of first design elements 14 as being substantially centered, as was discussed more fully above. The log can be but anywhere within the second zone 110. The placement of the first design elements 14 and the second design elements 16 can be done such that a consumer does not readily perceive the centerline 24 of the strip 12 of absorbent paper product 10, as shown in FIGS. 1 and 7. This design is therefore advantageous to manufacturers that produce absorbent paper products on high speed lines or with inaccurate equipment. The present disclosure allows manufacturers to produce a strip 12 of absorbent paper 10 comprising at least one first design element 14 and at least one second design element 16 that is preferable to consumers.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of manufacturing a strip of absorbent paper product, the method comprising:
providing a strip, the strip having a strip width comprising a first dimension disposed between a first edge and a second edge opposite the first edge and a centerline extending in a longitudinal direction equidistant between the first edge and the second edge;
imparting a pattern of first design elements in a central region wherein each first design element comprises a visual center point and the pattern has a pattern centerline in the longitudinal direction, the pattern of first design elements being disposed within a central width having a second dimension, the second dimension being less than the first dimension, and the central region extending laterally outwardly on each side of the centerline; and
imparting a plurality of second design elements on the strip, wherein at least one of second design elements is disposed in the central region, and wherein at least one of the second design elements is disposed in at least one of a first edge region and the second edge region, the first edge region and a second edge region each extending outward from the central region toward at least one of the first edge and the second edge.

2. The method of claim 1, further comprising perforating the strip to impart a line of weakness and define one or more sheets, wherein the line of weakness is a curvilinear shape comprising one or more perforations.

3. The method of claim 1, wherein said imparting is by printing a first design element in the central region of the strip.

4. The method of claim 1, wherein said imparting is by embossing a first design element in the central region of the strip.

5. The method of claim 1, wherein at least one of the second design elements is printed on the strip.

6. The method of claim 1, wherein at least one of the second design elements is embossed on the strip.

7. A method of applying a pattern to an absorbent paper product, the method comprising:
providing a strip, the strip having a strip width comprising a first dimension disposed between a first edge and a second edge opposite the first edge and a centerline extending in a longitudinal direction equidistant between the first edge and the second edge;
providing a pattern having a pattern centerline, the pattern comprising:
a plurality of first design elements, wherein each first design element comprises a visual center point, wherein the plurality of first design elements are disposed about the pattern centerline such that the sum of offsets of the visual center points of each first design elements disposed to one side of the pattern centerline is about equal to the sum of offsets of the visual center point of each first design element disposed to the opposite side of the pattern centerline, and wherein the pattern of first design elements being disposed within a central region having a central width having a second dimension, the second dimension being less than the first dimension; and
a plurality of second design elements, wherein at least one of second design elements is disposed in the central region, and wherein at least one of the second design elements extends over the central region;
imparting the pattern comprising the plurality of first design elements and plurality of second design elements onto the strip, wherein the pattern is disposed between the first edge and the second edge of the strip, and wherein the central region extends laterally outwardly on each side of the centerline, and wherein at least about 10% of the central width is positioned to one side of the centerline of the strip.

8. The method of claim 7, wherein the step of imparting is by at least one of printing the pattern on the strip and embossing the pattern on the strip.

9. The method of claim 7, further comprising wrapping the absorbent paper product in a packaging that is at least partially transparent, wherein at least one of the first design element and the second design element is visible through the package.

10. The method of claim 7, further comprising imparting a line of weakness onto the strip, wherein the line of weakness comprises one or more perforations extending substantially in the cross machine direction.

11. The method of claim 10, wherein the line of weakness is a curvilinear shape.

12. The method of claim 10, wherein at least one of the plurality of first design elements and the plurality of second design elements intersects the line of weakness.

13. The method of claim 7, wherein the centerline and the pattern centerline are in the same location on the strip.

14. The method of claim 7, wherein the centerline and the pattern centerline are in a different location on the strip.

15. A method of manufacturing a strip of absorbent paper product, the method comprising:
providing a strip, the strip having a strip width comprising a first dimension disposed between a first edge and a second edge opposite the first edge and a centerline extending in a longitudinal direction equidistant between the first edge and the second edge;
imparting a pattern of first design elements in a central region wherein each first design element comprises a visual center point and the pattern has a pattern centerline, in the longitudinal direction, the pattern of first design elements being disposed within a central width having a second dimension, the second dimension being less than the first dimension, and the central region extending laterally outwardly on each side of the centerline; and
imparting a plurality of second design elements on the strip, wherein at least one of second design elements is disposed in the central region, and wherein at least one of the second design elements is disposed in at least one of a first edge region and the second edge region, the first edge region and a second edge region each extending outward from the central region toward at least one of the first edge and the second edge; and
perforating the strip to impart a line of weakness and define one or more sheets, wherein the line of weakness is a curvilinear shape comprising one or more perforations.

16. The method of claim 15, wherein the step of imparting is by printing a first design element in the central region of the strip.

17. The method of claim 15, wherein the step of imparting is by embossing a first design element in the central region of the strip.

18. The method of claim 15, wherein the step of imparting is by printing at least one second design element on the strip.

19. The method of claim 15, wherein the step of imparting is by embossing at least one second design element on the strip.

20. The method of claim 15, wherein the centerline and the pattern centerline are in a different location on the strip.
